(19) United States
(12) Patent Application Publication
(10) Pub. No.: US 2026/0299752 A1
(43) Pub. Date: Oct. 1, 2026

(54) SYSTEM(S) AND METHOD(S) FOR SELECTION OF A MODEL TO BE UTILIZED IN PROCESSING PROMPTS

(71) Applicant: InChannel AI LLC, Sarasota, FL (US)

(72) Inventors: Daniel Perrone, Sarasota, FL (US); James A. Woods, Sarasota, FL (US)

(21) Appl. No.: 19/242,836

(22) Filed: Jun. 18, 2025

Related U.S. Application Data
(60) Provisional application No. 63/779,581, filed on Mar. 28, 2025.

(51) Int. Cl. G06F 3/0482

(52) U.S. Cl. CPC G06F 3/0482

(57) ABSTRACT

Implementations described here are direct towards methods for generating content based on user prompts by intelligently selecting a model from a pool of available models. The selection process can be based on explicit user selection, analysis of user data (such as occupation, interests, or previously used models), and/or classification of the available models. Once a model is selected, it processes the prompt, potentially supplemented with publicly available or user-provided data, to generate content. The generated content is presented to the user, and further actions can be initiated based on the user's interaction with selectable GUI elements. Additionally, the system can recommend suitable models to the user based on their data and the community's model usage. By processing the user data and taking that into consideration to select the model that best suits a user's needs it helps to eliminate and reduce the amount of wasted computation resources.

### BACKGROUND

Implementation of machine learning models has been limited to a narrow scope due to constraints on the inputs they can receive and the outputs they can generate based on those inputs. Generative models provide increased flexibility, but lack the specialization needed for widespread implementation into a variety of tasks. As a result, users resort to computationally burdensome interactions with machine learning models that are not specialized for the tasks they are utilized to process, thereby wasting computational resources as users must participate in lengthy engagements in order to obtain a satisfactory result.

### SUMMARY

Implementations disclosed herein recognize that processing a prompt provided by a user utilizing a model that was selected specifically for the prompt can result in the generation of content that is responsive to the prompt. Computational resources such as processing resources, memory resources, and network bandwidth are conserved by reducing the number of inputs required to be received, transmitted, and processed as well as the number of outputs required to be generated, transmitted, and received before the user's interaction with the model is complete.

Implementations described herein enable a prompt that is received based on user input, provided at an interface of a client device, to be processed utilizing one or more selected models to generate content based on the prompt. The content that is based on the prompt can be generated based on output of one or more of the selected models. In response to generating the content, one or more actions can be performed.

For example, a user can provide a prompt that states “Generate a new job listing for a Patent Attorney”. A model that has been trained in processing prompts to generate job listings can be selected to be used in processing the prompt provided by the user. Once the job listing for a Patent Attorney has been generated based on output of the model, one or more actions can be performed.

As one non-limiting example of the one or more actions, the job listing for the Patent Attorney can be posted to one or more websites. Additionally and/or alternatively, one or more of the actions can include causing the content to be rendered at the client device. For example, the job listing for the Patent Attorney can be rendered such that the user can review the content. In some implementations, one or more selectable graphical user interface (GUI) elements can be rendered along with the content. A user can provide input to select one or more of the selectable GUI elements, which can cause one or more additional actions to be performed in response. For example, a third party application, such as a job listing application, can be caused to perform one or more actions, such as posting the job listing for the Patent Attorney. Additionally and/or alternatively, the user selection of one or more of the selectable graphical user interface elements can indicate a dissatisfaction with the content. For example, one or more of the additional actions can be allowing the user to provide additional information as input to the model and causing the model to be used to process the prompt as well as the additional information.

Allowing the user to provide input to select one or more selectable GUI elements before causing one or more actions to be performed can prevent computational resource waste by reducing instances of actions from being performed using content that is unsatisfactory to the user, thereby decreasing instances when additional computation resources must be consumed in performing the actions repeatedly until a satisfactory result is achieved.

In some implementations, selection of the particular model that is to be used in processing the prompt to generate content that is based on the prompt can be based on a user input that indicates selection of the particular model. For example, multiple selectable GUI elements can be rendered at an interface of a client device. Each of the multiple selectable GUI elements can correspond to a respective model. The user can provide an input that indicates a selection of one or more of the multiple selectable GUI elements, and the model(s) that correspond to the selected selectable GUI elements can be selected to be used in processing the prompt. The user input that indicates the selection of the selectable GUI element(s), in some implementations, can be provided before the user provides the prompt, or alternatively, can be provided after the user provides the prompt.

In various implementations, selection of the particular model that is to be used in processing the prompt to generate content that is based on the prompt can be based on user data. For example, the user can provide one or more instances of user data. The user data can be stored in one or more databases. For example, the user data can be stored in a structured query language (SQL) database. Additionally and/or alternatively, one or more of the instances of user data can be stored in an additional database. For example, one or more embeddings can be generated based on one or more of the instances of user data, and the embeddings can be stored in a vector database. In some implementations, selection of the particular model that is to be used in processing the prompt to generate content that is based on the prompt can include comparing one or more of the embeddings to one or more additional embeddings that are generated based on one or more of the models.

In some implementations selection of the particular model that is to be used in processing the prompt to generate content that is based on the prompt can be based on a classification of one or more of the models. For example, a model with a classification of “Generative Job Listings” can be selected to be used in processing the prompt of “generate a job listing for a Patent Attorney” to generate a job listing for a patent attorney. The classification of the model(s) can be based on the function of the model. For example, classifications can include generative models, search models, identification models, classification models, etc. Additionally and/or alternatively, the models can be classified based on a particular type of content that the model has been trained to be utilized in processing. For example, image-based models, text-based models, sound-based models, and/or multimodal models. Additionally and/or alternatively the models can be classified based on a description of the model. For example, a developer can provide a description that states “This model can be utilized in generating content for job listings”.

In some implementations, after selecting the model, the particular model can be utilized in processing the prompt. Causing the particular model to be utilized in processing the prompts can include selecting one or more instances of publicly available data to be utilized as input to the model. For example, in processing the prompt of “generate a job listing for a Patent Attorney” to generate the job listing for the Patent Attorney, publicly available data can be identified and selected, such as publicly available salary information for Patent Attorneys, to be utilized as input to the particular model. Use of publicly available information as input to the model can increase the quality of the output by providing relevant context to the prompt that may be necessary in generating the content. By providing this data as input to the particular model, computation resources are conserved when a user does not have to provide multiple prompts for the model to be utilized in processing and the number of outputs generated using the particular model can be reduced.

In various implementations a user can provide an input to select one or more models that are to be used in processing one or more subsequently received prompts. For example, multiple selectable GUI elements can be rendered at an interface of a client device. Each of the selectable GUI elements can correspond to a respective model. A user input that indicates a selection of one or more of the GUI elements can indicate that the model that selectable GUI element corresponds to is to be used in processing one or more subsequent prompts.

Allowing a user to select a model to be used in processing subsequent prompts can reduce the consumption of computational resources, such as processing resources, that are required to select a particular model. In some implementations, additional computational resources can be conserved by presenting recommendations of models for the user to select based on one or more instances of user data. Presenting recommendations based on user data increases instances where a user is able to find a particular model to handle particular subsequent prompts. Additionally, presenting recommendations to the user decreases the inputs required to be processed as a user interacts with an interface of a client device to select one or more models.

In some implementations, the user data can be provided by the user and stored in one or more databases as set forth above. After the user data has been stored, one or more models to recommend to the user can be determined based on processing the user data. GUI elements that correspond to one or more of the models can be presented at an interface of a client device. The user can provide an input that is indicative of a selection of one or more of the GUI elements that correspond to one or more of the models, which can cause one or more of the models that were selected to be used in processing one or more subsequent prompts.

For example, a user can provide one or more instances of user data that indicate that the user is a Patent Attorney. Based on processing the user data that indicates that the user is a Patent Attorney, one or more models can be selected for recommendation. For example, a model that can be used in generating summaries of judicial opinions can be recommended. When the user provides a selection of a GUI element that corresponds to the judicial opinions specific model, that model can be selected to be utilized in processing prompts related to generating summaries of judicial opinions.

In various implementations, the user data provided by the user can be supplemented by user data that the user did not provide. Publicly available data that is relevant to the user can be identified and stored in one or more of the databases described above. For example, the user can provide a webpage associated with their Patent Law Firm. The webpage can include various links to social media of the various employees at Patent Law Firm. The linked social media page of the user can be identified and the user data can be stored in one or more of the databases.

In some implementations, determining one or more of the models to recommend to the user can include determining that one or more of the models have been utilized by one or more additional users. For example, a first model that has been utilized by one or more additional users more frequently than a second model can be recommended in lieu of the second model. In some implementations, a particular model can be recommended when a threshold number of additional users have utilized the particular model. For example, the threshold can be a static number, e. g, 1000 additional users. Additionally and/or alternatively, the threshold can be determined in relation to one or more other models. For example, the threshold can be satisfied when the additional users who have utilized the particular model are greater than a particular number of additional users who have utilized other models, such as recommending the top five models with the most additional users. As yet another example, the recommendation can be based on a number of additional users of a particular model within a time period.

In some implementations, determining one or more of the models to recommend to the user can include determining that one or more of the models have been utilized by one or more additional users, and/or that an embedding generated based on one or more instances of user data being compared to an additional embedding that is generated based on one or more additional instances of user data of the additional user(s).

In various implementations, determining one or more of the models to recommend to the user can be based on historical data. For example, one or more previous prompts of the user can be processed, and one or more of the models can be recommended to the user based on the previous prompts. The previous prompts can be compared to one another to determine a model to recommend to the user. Additionally and/or alternatively, the historical data can indicate that the user has used one or more models from a particular developer, and one or more models that the developer has created can be recommended based on the historical data.

In various implementations, once a model has been selected to be utilized in processing the query, it can be determined to request that the user provide additional information. The additional information can supplement the prompt and be utilized in generating content that is responsive to the prompt. For example, a patent attorney can submit a prompt of “generate a summary of shop-right laws in my area”, and, once a model has been selected, the user can be requested to provide additional information such as “What state are you currently located in?”. The user can provide the additional information and the model can be utilized in processing the prompt along with the additional information.

Requesting additional information from the user prior to using the model to process the request can result in more accurate and robust content that is generated as a result while using fewer computation resources. For example, instead of utilizing the model to process the prompt and generate responsive content, and then having to provide the additional information and use the model again to process the prompt along with the additional information to generate another instance of content that is responsive to the prompt, processing resources can be conserved by only using the model to process the prompt along with the additional information a single time. Additionally, network bandwidth can be conserved when excess transmissions of data are limited by utilizing the model in processing the prompt along with the additional information in limited interactions.

In various implementations, a GUI element can be rendered responsive to determining to request that the user provide the additional information. As set forth in the example above, a request can be visually rendered in a GUI element, such as “What state are you currently located in?” and additional information can be provided by the user in response to the request embodied in the GUI element. The additional information can be processed along with the prompt utilizing the selected model, and content that is responsive to the prompt and/or the additional information can be generated.

The preceding is provided as an overview of only some implementations disclosed herein. Those and implementations are described in more detail herein.

### BRIEF DESCRIPTION OF THE DRAWINGS

FIG. 1 depicts an example computing environment according to example implementations of the present disclosure.

FIG. 2 depicts a process flow of an example process using various components from the example environment from FIG. 1, in accordance with various implementations.

FIG. 3 depicts a flowchart illustrating an example method in accordance with various implementations.

FIG. 4 depicts a flowchart illustrating another example method in accordance with various implementations.

FIG. 5 depicts an example environment in which techniques described herein may be implemented.

FIG. 6 schematically depicts an example architecture of a computer system.

### DETAILED DESCRIPTION

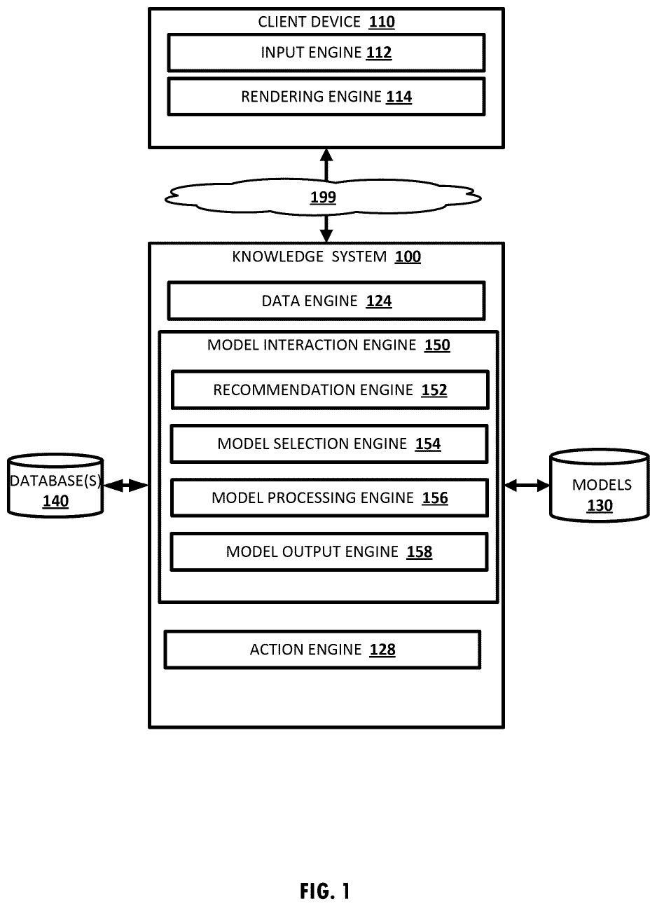

Turning now to FIG. 1, a block diagram depicts an example environment demonstrating aspects of the present disclosure and implementations disclosed herein. The example environment includes a client device 110. In some implementations, aspects of the client device 110 can be implemented remotely from the client device 110 (e.g., at remote server(s) and/or knowledge system 100). The client device 110 can be communicatively coupled with the knowledge system 100 via one or more networks 199, such as one or more wired or wireless local area networks (“LANs,” including Wi-Fi®, mesh networks, Bluetooth®, near-field communication, etc.) or wide area networks (“WANs”, including the Internet). Additionally and/or alternatively, one or more components of the knowledge system 100 can be implemented on the client device 110.

The client device 110 can be, as examples, one or more of: a desktop computer, a laptop computer, a tablet, a telephone including a mobile phones, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device).

The client device 110 can execute one or more software applications through which inputs provided by a user can be submitted and content responsive to those inputs can be rendered (e.g., audibly and/or visually). The client device 110 can execute one or more of the software applications separately from an operating system of the client device 110 (e.g., installed “on top” of the operating system), or the client device 110 can execute one or more of the software applications directly by the operating system of the client device 110. For example, the client device 110 can execute a web browser software application, a generative content software application, electronic communications software applications (e.g., email software application(s), messaging software application(s), social media software application(s), etc.), an automated assistant software application, etc., that is installed on top of the operating system of the client device 110. As another example, the client device 110 can one or more software applications that are integrated as part of the operating system of the client device 110.

In some implementations, the client device 110 can have an input engine 112 and a rendering engine 114. The input engine 112 can be configured to detect input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110. Additionally, or alternatively, the client device 110 can be equipped with one or more interfaces that are configured to receive content (e.g., document(s), image(s), video(s), audio, etc.) provided by the user of the client device 110.

In some implementations, the rendering engine 114 is configured to render content for audible or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as visual content, such as text, along with other visual content (e.g., image(s), video(s), etc.), via the client device 110.

Further, the client device 110 can include one or more memories for storage of data or software applications, one or more processors for accessing data and executing the software applications, or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device 110 having a single user, it should be understood that is for the sake of example and is not meant to be limiting. For example, additional client devices of a user or of additional user(s) can also implement the techniques described herein. For instance, the client device 110, the additional client devices, or computing devices of a user can form an ecosystem of devices that can employ techniques described herein. These additional client devices or computing devices may be in communication with the client device 110 (e.g., over the network(s) 199). As another example, a client device can be utilized by multiple users in a shared setting (e.g., a group of users, a household, a workplace, a hotel, etc.).

FIG. 1 depicts the client device 110 as being communicatively coupled with a knowledge system 100 via one or more of the network(s) 199. The knowledge system 100 can include a data engine 124, a model interaction engine 150, and/or an action engine 128. The model interaction engine 150 can include a recommendation engine 152, a model selection engine 154, a model processing engine 156, and a model output engine 158. The knowledge system 100 can have access to one or more models 130 and/or one or more databases 140.

The data engine 124 can be configured to collect user data and to store this data in one or more databases 140. User data can be received from the user, and/or, can be collected from publicly available sources. The data engine 124 can additionally and/or alternatively be configured to collect and store other types of data. As a few non-limiting examples, the data engine 124 can identify and store data related to one or more of the models 130, data related to one or more entities, such as locations, people, and/or things, and/or data related to particular industries, regions, and/or topics.

In some implementations, the data engine 124 can generate representations of one or more instances of data, such as embeddings. The data engine 124 can generate representations of data based on one or more requirements of a particular database. For example, the data engine can cause embeddings to be generated based on one or more instances of data according to one or more requirements of a vector database. The data engine 124 can cause one or more instances of data, and/or representations thereof, to be stored in one or more databases 140.

The databases 140 can include, for example, structured query language (SQL) databases, vector databases, or other types of databases suitable for storing and managing data. This data can be leveraged by other components of the knowledge system 100 to provide improved functionality and personalized experiences for the user.

In various implementations, the recommendation engine 152 can process various data to recommend one or more of the models 130 for a user to utilize in processing one or more input prompts. The recommendation engine 152 can leverage data, such as user data, historical data, metadata for one or more of the models 130, real time feedback, etc., to generate one or more model recommendations.

In some implementations, the models 130 can include various types of models such as machine learning models, generative models, multimodal models, and others. One or more of the models can be configured to be used in generating generative content as output. Additionally and/or alternatively, one or more of the models 130 can be used in producing output that includes instructions that cause one or more software applications to perform one or more actions. In some implementations, output of one or more of the models 130 can include structured data that can be utilized in generating content that is responsive to a prompt.

In some implementations, the model selection engine 154 can identify and select one or more models 130 to be utilized in processing an in input prompt. The model selection engine can leverage data, such as inputs received at a client device, user data, historical data, metadata for one or more of the models 130, real time feedback, etc., to select one or more of the models 130. The model selection engine 154 can select one or more models 130 to be used in processing a prompt based on the prompt.

In some implementations, input prompts can be processed by the model processing engine 156 using one or more of the models 130. Once the model processing engine 156 has processed the input prompt using one or more of the models 130, the model output engine 158 can receive the output that was generated using one or more of the models 130. In some implementations, the model output engine 158 can generate content based on the output of one or more of the model(s) 130.

In some implementations, the action engine 128 can cause one or more actions to be performed. For example, the action engine 128 can provide output of one or more of the models 130, and/or content that is generated based on output of one or more of the models 130, to the rendering engine 114 of the client device 110. Additionally and/or alternatively, the action engine 128 can cause one or more third party applications to be perform one or more actions.

While FIG. 1 is depicted having components executing on the client device and components executing within a knowledge system 100 that is separate from the client device 110, it should be understood that is for the sake of example and is not meant to be limiting. For example, one or more of the components depicted in FIG. 1 as executing on the client device 110 may alternatively be implemented at the knowledge system 100. Additionally or alternatively, one or more of the components depicted in FIG. 1 as executing at the knowledge system 100 may alternatively be implemented at the client device 110. Furthermore, many of the components discussed in FIG. 1 may function in the same or similar fashion in a distributed computing environment, such as in the network(s) 199.

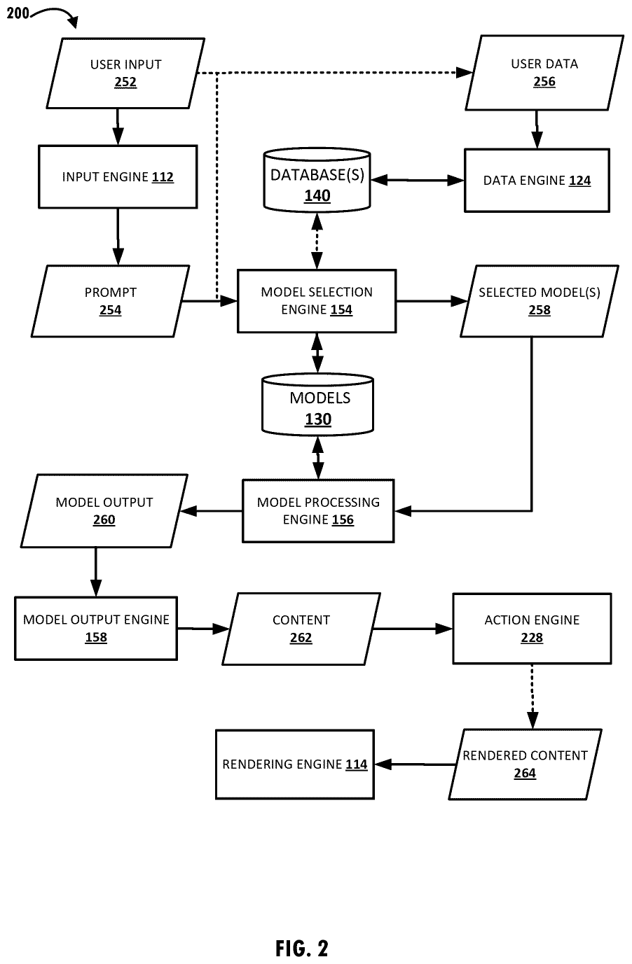

FIG. 2 depicts a process flow of an example process using various components from the example environment from FIG. 1, in accordance with various implementations. For convenience, the process 200 will be described with reference to FIG. 1. The process 200 begins when the input engine 112 receives user input 252. The user input 252 received at the input engine 112 can be, for example, an unstructured natural language input (e.g., typed input) and/or a free-form natural language input (e.g., spoken input). The user input 252 received at the input engine 112 can be, for example, generated by an assistant engine and/or application executing at the client device 110. For example, the user input 252 received at the input engine 112 can be received in response to and/or based on an assistant engine executing at the client device 110 determining that the user input 252 corresponds to a task that an application executing at the client device 110 can be used in fulfilling.

In some implementations, the user input 252 can correspond to a prompt 254. The prompt 254 can include image data and/or video data, or data representative of one or more images and/or videos. Additionally and/or alternatively, the prompt 254 can include one or more instances of audio data. The prompt 254 can be natural language textual input that is generated based on the user input 252. The prompt 254 can additionally and/or alternatively be structured data that is generated based on the user input 252.

In various implementations, the model selection engine 154 can select, from one or more models 130, one or more selected models 258. The selected model(s) 258 can be selected based on the prompt 254. For example, the model selection engine 154 can perform initial processing of the prompt 254 and one or more of the selected models 258 can be selected by the model selection engine 154 based on content of the prompt 254. In some implementations, the prompt 254 can specify one or more of the models 130 for the model selection engine 154 to select as selected models 258. Alternatively and/or additionally, the model selection engine 154 can select one or more of the models 130 as selected models 258 based on user input 252. For example, the user can provide user input 252 that is indicative of a selection of one or more of the models 130 to select as the selected models 258. As one non-limiting example, the user input 252 can be a selection of one or more GUI elements that correspond to one or more of the models 130. Based on the selection of one or more of the GUI elements, the model selection engine 154 can select one or more of the models 130 as the selected models 258.

In some implementations, the model selection engine 154 can utilize user data 256 that a data engine 124 has stored in one or more databases 140 to select one or more of the models 130 as the selected models 258. The user data 256 can be provided by the user and/or can be acquired from one or more publicly available data sources. The data engine 124 can cause the user data 256 to be stored in one or more of the databases 140. This can include generating representations of the user data 256 according to one or mor requirements of one or more of the databases 140. For example, embeddings of the user data 256 can be generated and stored in a vector database. The model selection engine 154 can leverage the user data 256 stored in the databases 140 in selecting one or more of the models 130 as selected models 258.

In various implementations, the model processing engine 156 can utilize the selected models 258 in processing the prompt 254 and/or any additional information that is in addition to the prompt 254 to generate model output 260. In some implementations, the model output 260 can be generative content that is responsive to the prompt 254. Additionally and/or alternatively, the model output 260 can be structured data.

The model output engine 158 can generate content 262 that is responsive to the prompt 254 based on the model output 260. For example, in implementations where the model output 260 is generative content, generating the content 262 can include formatting the model output 260 such that it can be rendered at an interface of a client device. Additionally and/or alternatively, the model output engine 158 can generate content 262 based on model output 260 that is structured data. For example, the model output engine 158 can cause one or more software applications to generate content 262 based on the structured data model output 260.

In some implementations, the action engine 128 can cause one or more actions to be performed based on the content 262. For example, the action engine 128 can generate rendered content 264 by causing the rendering engine 114 to render the content 262 via one or more output components of a client device. Additionally and/or alternatively, the action engine 128 can cause one or more software applications to perform one or more actions, such as posting the content 262 to a website. The action engine 28 can leverage the rendering engine 114 to cause one or more GUI elements to be rendered at a client device. Selection of one or more of the GUI elements can cause the action engine 128 to cause one or more additional actions to be performed, such as revising the prompt, acquiring additional information to be processed by one or more of the models, or one or more software applications to perform one or more actions.

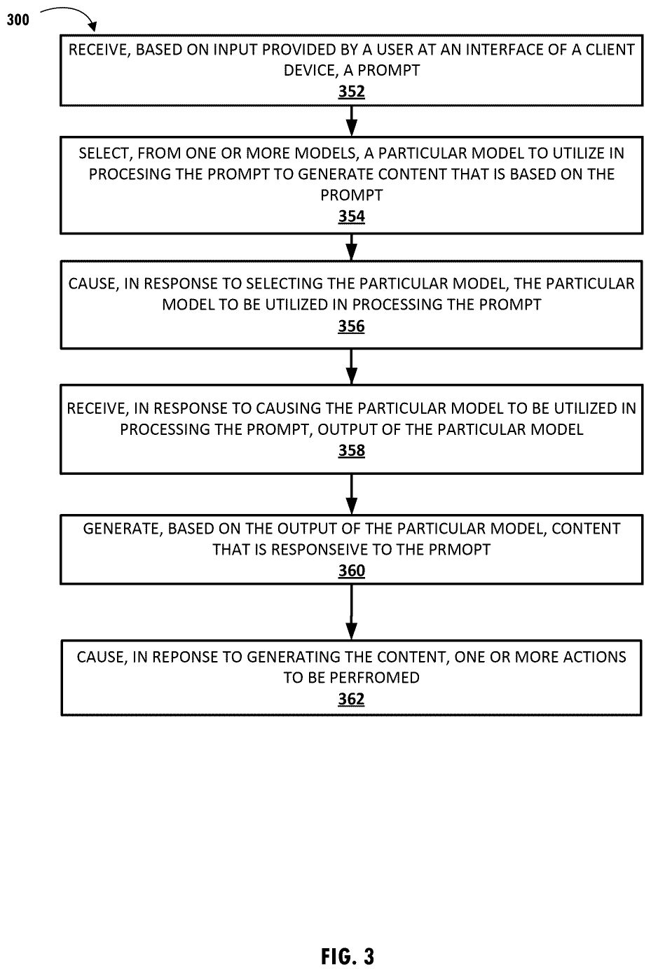

Turning now to FIG. 3, a flowchart is depicted that illustrates an example method 300 in accordance with various implementations. For convenience, the operations of the flow chart are described with reference to a system that performs the operations. The system of method 300 includes at least one processor, memory, and/or other component(s) of computing device(s). Moreover, while the operations of the method 300 are shown in a particular order, this is not meant to be limiting. One or more operations may be reordered, omitted, and/or added.

At block 352, the system may receive a prompt based on an input provided by a user at an interface of a client device. In some implementations, the input provided by the user can be textual input and/or spoken input. Additionally and/or alternatively, the input can be a visual input, such as a gesture or eye movement. The input can be captured via one or more textual input devices that are communicatively linked to the client device, such as a keyboard. The input can additionally and/or alternatively be captured by one or more microphones and/or one or more cameras of the client device.

At block 354, the system may select a particular model from one or more models to utilize in processing the prompt to generate content that is based on the prompt. In some implementations, selecting the particular model can include receiving, based on an initial input provided by a user at the interface of the client device, a selection of the particular model, where selecting the particular model to utilize in processing the query is based on the initial input. For example, a user can provide an input that indicates a selection of a GUI element that corresponds to a particular model. The selection of the GUI element can cause the corresponding particular model to be selected to be utilized in processing the prompt.

In some implementations, selecting the particular model can include accessing user data for the user that provided the input at the interface of the client device, where selecting the particular model to utilize in processing the query may be based on the user data. In various implementations, the user data can indicate one or more models previously utilized by the user. Additionally and/or alternatively, the user data can be indicative of one or more features of the user, such as occupation, interests, skills, capabilities, location, language preferences, and other features.

As one non-limiting example, a user can provide a prompt of “Generate an overview of Patent Law”. The user data can indicate that the user works at an American law firm. A model that has been trained to be utilized in processing prompts that are related to American patent law can be selected based on the user data that indicates that the user works at an American law firm.

In some implementations, selecting the particular model can include comparing an embedding of the user data to one or more embeddings of one or more of the models, and selecting the particular model to utilize in processing the query based on comparing the embedding of the user data to one or more of the embeddings of one or more of the models. In various implementations. In some implementations, selecting the particular model to utilize in processing the query may be based on a classification assigned to the particular model.

The user data may be provided by the user and/or can be collected from one or more public sources. In some implementations, user data can be collected from one or more public sources based on user data that was provided by the user. For example, user provided user data can be processed, and one or more public sources of user information can be identified.

As one non-limiting example, a user can provide a company website as user data. The company website can include user profiles that have links to employee social media accounts. the user's social media account can be identified based on processing the company website, and one or more instances of user data can be collected and stored from the users social media account. Access to non-user provided data can be controlled by the user.

At block 356, the system can cause, in response to selecting the particular model, the particular model to be utilized in processing the prompt. In some implementations, causing the particular model to be utilized in processing the prompt can include selecting one or more instances data to be utilized as input to the model in addition to the prompt. The data can be user provided data and/or publicly available data. In some implementations, the data can include one or more instances of user data to be utilized as input to the model.

At block 358, the system may receive, in response to causing the particular model to be utilized in processing the prompt, output of the particular model. Output of the particular model can include, for example, generative content, structured data that can be used in generating content that is responsive to the prompt, and/or instructions that can cause one or more software applications to perform one or more actions.

At block 360, the system can generate content, based on the output of the particular model, that is responsive to the prompt. In some implementations, generating the content can include receiving generative content from a generative model. Additionally and/or alternatively, generating the content can be based on structured data received as output from one of the models. In some implementations, generating the content includes using the output of one or more of the models to cause a software application to perform one or more actions.

At block 362, the system can cause, in response to generating the content, one or more actions to be performed. In some implementations, causing one or more actions to be performed can include causing the content to be rendered at the interface of the client device. Additionally and/or alternatively, causing one or more actions to be performed can include causing one or more software applications to perform one or more actions. The software application can be a third-party application.

In some implementations, causing the content to be rendered at the interface of the client device may include causing one or more selectable GUI elements to be rendered along with the content at the interface of the client device. The system can receive, based on an additional input provided by the user at the interface of the client device, a selection of one or more of the selectable GUI elements; and cause, in response to receiving the selection of one or more of the selectable GUI elements, one or more additional actions to be performed. In some implementations, the additional actions can include causing a software application to perform one or more of the additional actions.

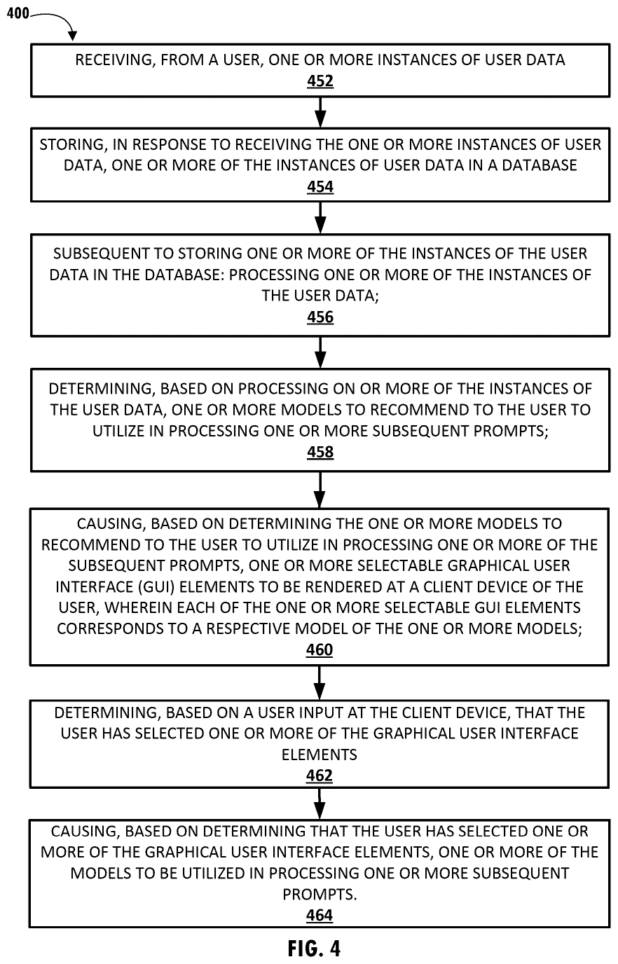

Turning now to FIG. 4, a flowchart is depicted that illustrations an example method 400 in accordance with various implementations. For convenience, the operations of the flow chart are described with reference to a system that performs the operations. The system of method 400 includes at least one processor, memory, and/or other component(s) of computing device(s). Moreover, while the operations of the method 400 are shown in a particular order, this is not meant to be limiting. One or more operations may be reordered, omitted, and/or added.

At block 452, the system may receive, from a user, one or more instances of user data. The user data may be provided by the user and/or can be collected from one or more public sources. In some implementations, user data can be collected from one or more public sources based on user data that was provided by the user. For example, user provided user data can be processed, and one or more public sources of user information can be identified. In various implementations, the user data can indicate one or more models previously utilized by the user. Additionally and/or alternatively, the user data can be indicative of one or more features of the user, such as occupation, interests, skills, capabilities, location, language preferences, and other features.

At block 454, the system may store, in response to receiving the one or more instances of user data, one or more of the instances of user data in a database. In some implementations, block 454 can include identifying, based on the one or more instances of user data received from the user, one or more additional instances of user data, and storing one or more of the additional instances of the user data in the database. As an example, a user can provide a webpage associated with their Patent Law Firm. The webpage can include various links to social media of the various employees at Patent Law Firm. The linked social media page of the user can be identified and the user data can be stored in one or more of the databases.

In various implementations, the database can be a Structured Query Language (SQL) database. Additionally and/or alternatively, the database can be a vector database. In some implementations, the system can include more than one database. Storing one or more instances of user data in the database can include generating representations of one or more instances of the user data, such as an embedding.

At block 456, subsequent to storing one or more of the instances of the user data in the database, the system may process one or more of the instances of the user data. For example, documents provided by the user can be processed. In some implementations, one or more embeddings that are representative of one or more instances of user data can be processed.

At block 458, the system may determine, based on processing one or more of the instances of the user data, one or more models to recommend to the user to utilize in processing one or more subsequent prompts. The system can determine to recommend one or more models to the user based on the type of model. For example, the system can determine, based on processing one or more instances of the user data, to recommend a generative model to the user.

In some implementations, determining one or more models to recommend can include determining that one or more additional users have utilized one or more of the models in processing one or more prior prompts. As an example, a first model that has been utilized by one or more additional users more frequently than a second model can be recommended in lieu of the second model. A determination to recommend a particular model can be based on a number of additional users that have utilized the model in processing one or more prompts satisfying a threshold.

In some implementations, determining one or more models to recommend to the user can be based on historical user data. For example, historical user data that indicates one or more other models that the user has utilized in processing one or more prior prompts.

In various implementations, determining one or more models to recommend to the user can be based on one or more embeddings. For example, one or more first embeddings generated based on one or more instances of user data can be compared to one or more second embeddings generated based on metadata associated with one or more of the models, and determining one or more of the models to recommend to the user can be based on the comparison. As another example, one or more of the first embeddings generated based on one or more instances of user data can be compared to one or more second embeddings that are generated based on one or more instances of additional user data from one or more additional users, and determining one or more of the models to recommend to the user can be based on the comparison. One or more additional users can be identified based on the comparison, and one or more models utilized by one or more of the additional users can be determined to be recommended to the user. The one or more first embeddings generated based on one or more instances of the user data can be indicative of one or more models utilized by the user in processing one or more prompts.

At block 460, the system may cause, based on determining the one or more models to recommend to the user to utilize in processing one or more of the prompts, one or more selectable graphical user interface (GUI) elements to be rendered at a client device of the user, where each of the one or more selectable GUI elements corresponds to a respective model of the one or more models. For example, the system can cause one or more selectable GUI elements to be rendered based on constraints associated with a particular display of the client device.

In some implementations, causing one or more selectable graphical user interface (GUI) elements to be rendered at a client device of the user can include rendering the GUI elements in based on a determination of which models the user is more likely to select. For example a determination can be made that a user has a first probability of selecting a first model and a second probability of selecting a second model. A first GUI element that corresponds to the first model can be rendered more prominently (e. g, first in an ordered list, larger, more colorful, etc.) than a second GUI element that corresponds to a second model. In some implementations, the first GUI element can replace the second GUI element in the display.

At block 462, the system may determine, based on a user input at the client device, that the user has selected one or more of the graphical user interface elements. The input can be, for example, provided at a graphical display of the client device using one or more connected device such as a mouse, keyboard, and/or touch screen. Additionally and/or alternatively, the input can be verbal and captured via one or more microphones, and/or visibly detectable and captured via one or more cameras of the client device.

At block 464, the system may cause, based on determining that the user has selected one or more of the graphical user interface elements, one or more of the models to be utilized in processing one or more subsequent prompts. causing the model to be utilized in processing one or more subsequent prompts can be performed in the same or similar manner as set forth above with respect to example method 300.

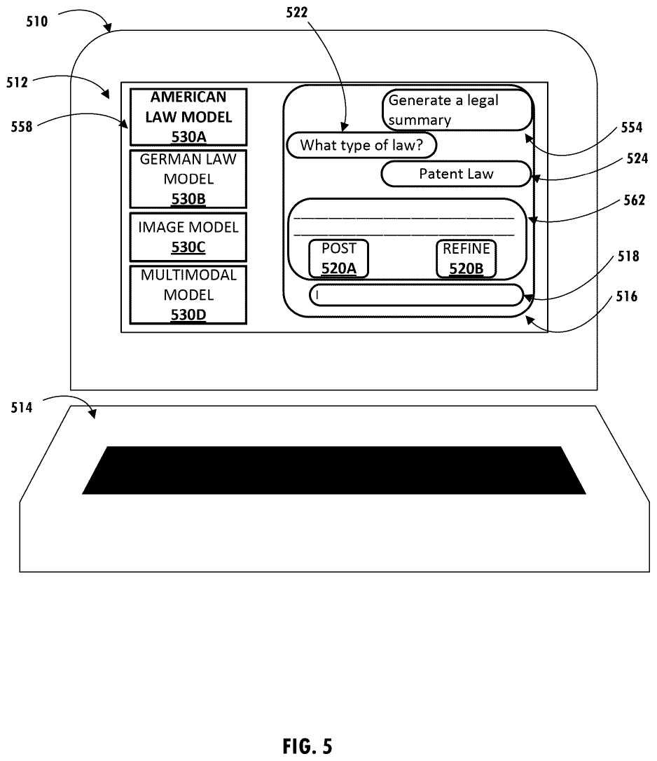

Turning now to FIG. 5, various non-limiting examples of the implementations described herein are depicted. In the example environment, a client device 510 is depicted. While the client device 510 is depicted as a laptop computer, this is not meant to be limiting. The client device 510 can additionally and/or alternatively be a desktop computer, a mobile phone, a tablet, or any other computing device. The client device 510 can include one or more output mechanisms, such as a display 512. While the client device 510 of FIG. 5 is depicted as having a display 512, this is not meant to be limiting. For example, the client device could additionally and/or alternatively include one or more audible output mechanisms, such as speaker, and/or one or more haptic output mechanisms. The client device 510 can include one or more input mechanisms. As one non-limiting example, the client device 510 has a keyboard 514. However, the client device 510 can additionally and/or alternatively include a touch screen, a microphone, a camera, and/or other sensors/input devices.

The client device 510 can render various GUI elements via the display 512. For example, model GUI elements 530A-D can be representative of one or more models that are available to the user to utilize in processing inputs to generate content. As another example, a GUI element can include a system interface GUI element 516. The system interface GUI element 516 can display user inputs to the system interface in addition to outputs of the system.

In various implementations, a user can provide input via one or more of the input mechanisms, such as the keyboard 514. In some implementations, the input can be provided at an input GUI element 518 that is rendered at the display 512 of the client device 510. Providing the input at the input GUI element 518 can cause the generation of a prompt 554. The prompt 554 can be rendered at the display 512 of the client device 510.

In some implementations, and as described above, a particular model 558 can be selected to be used in generating content 562 that is responsive to the prompt 554. In some implementations, an indication that the particular model 558 has been selected can be rendered. For example, the model GUI element 530A can be rendered in response to selecting the “American Law Model” to be utilized in processing the prompt 554. In some implementations, a previously generated model GUI element 530A-D can be modified to indicate the model is the particular model 558 selected to be used in generating content 562 that is responsive to the prompt. For example model GUI element 530A can be highlighted, have one or more features bolded, enlarged, moved to the top of an ordered list, or other modifications.

In some implementations, the selection of the particular model 558 can be based on user input that indicates a selection of the model GUI element 530A that corresponds to the particular model 558. For example, the user can click or tap on model GUI element 530A to select the particular model 558. In response to the selection, the model GUI element 530A can be modified as described above. In various implementations, the particular model 558 is not selected by the user, but is instead selected based on the prompt 554 and/or other data. In these implementations, selection of the particular model 558 as described can result in the modification of model GUI element 530A in the same or similar way as described above. For example, in response to the prompt of “Generate a legal summary”, the particular model 558 can be selected because it is specialized for the topics of law, as indicated by the description “American Law Model”, in lie of the “Image model” and/or the “multimodal model”. Additionally and/or alternatively, user data can be used in selecting the particular model 558. For example, user data can indicate that the user is located in America. As a result the “American Law Model” can be selected as the particular model 558 in lieu of the “German Law Model”.

In some implementations, selection of the particular model 558 can be followed by utilizing the model in processing the prompt 554 to generate content 562 that is responsive to the prompt 554. The content 562 can be rendered at the display 512 of the client device 510. The content 562 can be rendered along with one or more additional action GUI elements 520A-B. Selection of one or more of the additional action GUI elements 520A-B can cause one or more additional actions to be performed. For example, selection of the additional action GUI element 520A can cause the content 562 to be posted to one or more websites, while selection of the additional action GUI element 520B can allow the user to refine the content 562 by providing modification to the prompt 554.

In various implementations the system can generate a request 522. The request 522 can be for additional information to be processed with the prompt 554 utilizing the particular model 558. For example, in response to the prompt 554 of “Generate a legal summary”, the system can generate a request 522 of “What type of law?”, to which the user can provide a response 524 of “Patent Law”. The response 524 can be processed along with the prompt 554 to generate content 562 that is a summary of patent law. In some implementations, a new prompt can be generated based on the response 524 the originally submitted prompt 554, and the content 562 can be generated based on the new prompt. In some implementations, selection of the particular model 558 can be based on the response 524 to the request.

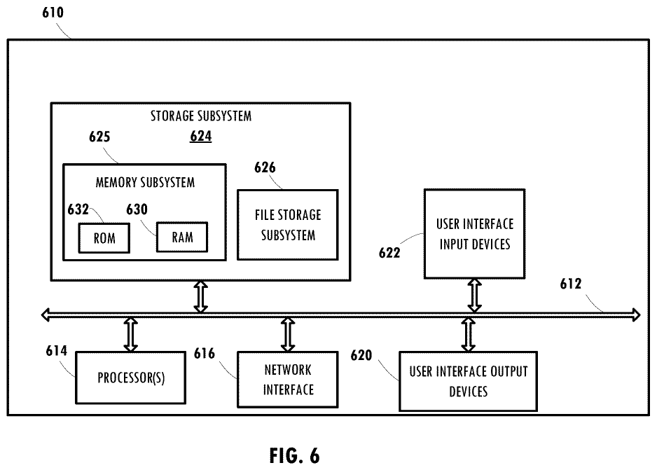

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods disclosed herein, and/or to implement one or more aspects of the various components depicted in FIG. 1. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a CD-ROM drive, an optical drive, or removable media cartridges. Modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple buses.

Computer system 610 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In some implementations, a method implemented by processor(s) is provided and includes receiving, based on input provided by a user at an interface of a client device, a prompt. The method includes selecting, from one or more models, a particular model to utilize in processing the prompt to generate content that is based on the prompt. The method includes causing, in response to selecting the particular model, the particular model to be utilized in processing the prompt. The method further includes receiving, in response to causing the particular model to be utilized in processing the prompt, output of the particular model. The method also includes generating, based on the output of the particular model, content that is responsive to the prompt. The method additionally includes causing, in response to generating the content, one or more actions to be performed.

In some implementations, causing one or more of the actions to be performed can include that the content can be rendered at the interface of the client device.

In some of those implementations, causing the content to be rendered at the interface of the client device can include that one or more selectable GUI elements can be rendered along with the content at the interface of the client device.

In some versions of those implementations, the method can further include receiving, based on an additional input provided by the user at the interface of the client device, a selection of one or more of the selectable GUI elements; and causing, in response to receiving the selection of one or more of the selectable GUI elements, one or more additional actions to be performed.

In some versions of those implementations, causing one or more of the additional actions to be performed can include causing a third-party application to perform one or more of the additional actions.

In some implementations, selecting the model to utilize in processing the query to generate content based on the prompt can include that, based on an initial input provided by a user at the interface of the client device, a selection of the particular model can be received, and selecting the particular model to utilize in processing the query can be based on the initial input.

In some implementations, selecting the particular model to utilize in processing the query can include that user data for the user that provided the input at the interface of the client device can be accessed, and selecting the particular model to utilize in processing the query can be based on the user data.

In some of those implementations, selecting the particular model based on the user data can include that an embedding of the user data can be compared to one or more embeddings of one or more of the models, and the particular model can be selected to utilize in processing the query based on comparing the embedding of the user data to one or more of the embeddings of one or more of the models.

In some versions of those implementations, the user data can be provided by the user.

In some implementations, selecting the particular model to utilize in processing the query can be based on a classification assigned to the particular model.

In some implementations, causing the particular model to be utilized in processing the prompts can include that one or more instances of publicly available data can be selected to be utilized as input to the model.

In some implementations, causing the particular model to be utilized in processing the prompts can include that, based on the particular model, one or more instances of user data can be selected to be utilized as input to the model.

In some implementations, a method implemented by processor(s) is provided and includes receiving, from a user, one or more instances of user data. The method further includes storing, in response to receiving the one or more instances of user data, one or more of the instances of user data in a database. The method also includes, subsequent to storing one or more of the instances of the user data in the database, processing one or more of the instances of the user data. The method further includes determining, based on processing one or more of the instances of the user data, one or more models to recommend to the user to utilize in processing one or more subsequent prompts. The method also includes causing, based on determining the one or more models to recommend to the user to utilize in processing one or more of the prompts, one or more selectable graphical user interface (GUI) elements to be rendered at a client device of the user, where each of the one or more selectable GUI elements corresponds to a respective model of the one or more models. The method further includes determining, based on a user input at the client device, that the user has selected one or more of the graphical user interface elements. The method also includes causing, based on determining that the user has selected one or more of the graphical user interface elements, one or more of the models to be utilized in processing one or more subsequent prompts.

In some implementations, determining the one or more models to recommend to the user to utilize in processing one or more of the subsequent prompts can include determining that one or more additional users can have utilized one or more of the models in processing one or more prior prompts.

In some of those implementations, determining the one or more models to recommend to the user to utilize in processing one or more of the subsequent prompts can further include generating, based on the user data, a first embedding; and generating, based on additional user data for one or more of the additional users, one or more second embeddings, where determining the one or more models to recommend to the user to utilize in processing one or more of the subsequent prompts can be based on a comparison of the first embedding and the second embedding.

In some versions of those implementations, determining the one or more models to recommend to the user to utilize in processing one or more of the subsequent prompts can include comparing one or more of the prior prompts that one or more of the additional users can have utilized one or more of the models to process to one or more additional prior prompts submitted by the user, where determining the one or models to recommend to the user to utilize in processing one or more of the subsequent prompts can be based on the comparison.

In some implementations, the method can further include identifying, based on the one or more instances of user data received from the user, one or more additional instances of user data; and storing one or more of the additional instances of the user data in the database.

In some implementations, the database can be a structured query language (SQL) database.

In some implementations, the method can further include generating, based on one or more instances of the user data, one or more embeddings; and storing, in response to generating the one or more embeddings, one or more of the embeddings in an additional database.

In some versions of those implementations, the additional database can be a vector database.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the methods disclosed herein. Some implementations include one or more computer-readable storage media (e.g., transitory and/or non-transitory) storing computer instructions executable by one or more processors to perform any of the methods disclosed herein. Some implementations include a computer program product including instructions executable by one or more processors to perform any of the disclosed herein.

We claim:

1. A method implemented by one or more processors, the method comprising:
receiving, based on input provided by a user at an interface of a client device, a prompt;
selecting, from one or more models, a particular model to utilize in processing the prompt to generate content that is based on the prompt;
causing, in response to selecting the particular model, the particular model to be utilized in processing the prompt;
receiving, in response to causing the particular model to be utilized in processing the prompt, output of the particular model;
generating, based on the output of the particular model, content that is responsive to the prompt; and
causing, in response to generating the content, one or more actions to be performed.

2. The method of claim 1, wherein causing one or more of the action to be performed comprises:
causing the content to be rendered at the interface of the client device.

3. The method of claim 2, wherein causing the content to be rendered at the interface of the client device comprises:
causing one or more selectable GUI elements to be rendered along with the content at the interface of the client device.

4. The method of claim 3, further comprising:
receiving, based on an additional input provided by the user at the interface of the client device, a selection of one or more of the selectable GUI elements; and
causing, in response to receiving the selection of one or more of the selectable GUI elements, one or more additional actions to be performed.

5. The method of claim 4, wherein causing one or more of the additional actions to be performed comprises:
causing a third-party application to perform one or more of the additional actions.

6. The method of claim 1, wherein selecting the model to utilize in processing the query to generate content based on the prompt comprises:
receiving, based on an initial input provided by a user at the interface of the client device, a selection of the particular model, wherein selecting the particular model to utilize in processing the prompt is based on the initial input.

7. The method of claim 1, wherein selecting the particular model to utilize in processing the query comprises:
accessing user data for the user that provided the input at the interface of the client device, wherein selecting the particular model to utilize in processing the prompt is based on the user data.

8. The method of claim 7, wherein selecting the particular model based on the user data comprises:
comparing an embedding of the user data to one or more embeddings of one or more of the models; and
selecting the particular model to utilize in processing the query based on comparing the embedding of the user data to one or more of the embeddings of one or more of the models.

9. The method of claim 7, wherein the user data is provided by the user.

10. The method of claim 1, wherein selecting the particular model to utilize in processing the prompt is based on a classification assigned to the particular model.

11. The method of claim 1, wherein causing the particular model to be utilized in processing the prompts comprises:
selecting one or more instances of publicly available data to be utilized as input to the model.

12. The method of claim 1, wherein causing the particular model to be utilized in processing the prompts comprises:
selecting, based on the particular model, one or more instances of user data to be utilized as input to the model.

13. A system comprising:
memory storing instructions; and
one or more processors operable to execute the instructions to:
receive, based on input provided by a user at an interface of a client device, a prompt;
select, from one or more models, a particular model to utilize in processing the prompt to generate content that is based on the prompt;
cause, in response to selecting the particular model, the particular model to be utilized in processing the prompt;
receive, in response to causing the particular model to be utilized in processing the prompt, output of the particular model;
generate, based on the output of the particular model, content that is responsive to the prompt; and
cause, in response to generating the content, one or more actions to be performed.

14. The system of claim 13, wherein in causing one or more of the action to be performed, one or more of the processors are to:
cause the content to be rendered at the interface of the client device.

15. The system of claim 14, wherein in causing the content to be rendered at the interface of the client device, one or more of the processors are to:
cause one or more selectable GUI elements to be rendered along with the content at the interface of the client device.

16. The system of claim 15, wherein one or mor of the processors are further operable to:
receive, based on an additional input provided by the user at the interface of the client device, a selection of one or more of the selectable GUI elements; and
cause, in response to receiving the selection of one or more of the selectable GUI elements, one or more additional actions to be performed.

17. The system of claim 16, wherein in causing one or more of the additional actions to be performed, one or more of the processors are to:
cause a third-party application to perform one or more of the additional actions.

18. The system of claim 13, wherein in selecting the model to utilize in processing the query to generate content based on the prompt, one or more of the processors are to:
receive, based on an initial input provided by a user at the interface of the client device, a selection of the particular model, wherein selecting the particular model to utilize in processing the prompt is based on the initial input.

19. The system of claim 13, wherein in selecting the particular model to utilize in processing the query, one or more of the processors are to:
access user data for the user that provided the input at the interface of the client device, wherein selecting the particular model to utilize in processing the prompt is based on the user data.

20. The system of claim 7, wherein in selecting the particular model based on the user data, one or more of the processors are to:
compare an embedding of the user data to one or more embeddings of one or more of the models; and
select the particular model to utilize in processing the query based on comparing the embedding of the user data to one or more of the embeddings of one or more of the models.
